(19) United States
(12) Patent Application Publication
(10) Pub. No.: US 2002/0172738 A1
(43) Pub. Date: Nov. 21, 2002

(54) Alcohol sweetened and sparkling fruit ciders and method for same

(76) Inventor: Thomas B. Young III, (US)

Correspondence Address: GALGANO & BURKE, 300 RABRO DRIVE, 300 RABRO DRIVE, SUITE 135, HAUPPAUGE, NY, 11788, US

(21) Appl. No.: 09/547,553

(22) Filed: Apr. 12, 2000

Related U.S. Application Data
(60) Provisional application No. 60/153,499, filed on Sep. 13, 1999.

(51) Int. Cl. C12G 1/00

(52) U.S. Cl. 426/15

(57) ABSTRACT

An alcoholic, sparkling, sweetened fruit cider with Ethanol content in the range 3.5% to 7.5% made by:

selecting a fruit juice or puree to form the desired flavor base of the beverage from a group comprising orange juice, grapefruit juice, pineapple juice, cherry juice, tomato juice, blueberry juice or puree, cranberry juice or puree, blackberry juice or puree, apricot juice or puree, prune juice, guava juice or puree, raspberry juice or puree, peach juice, lemon juice, lime juice, strawberry juice or puree, and kiwi fruit juice or puree, adding yeast and a nutrient mineral salts mixture as set forth in TABLE I below:

TABLE I

| | gms per 100 gms |
|---|---|
| Ammonium chloride | 61 |
| Yeast extract | 3 |
| Potassium phosphate | 20 |
| Magnesium sulfate heptahydrate | 14 |
| Thiamine hydrochloride | 2 |

adding sugar derived from corn, cane, beet or barley malt as required to establish an initial sugar level in the 8 to 14% w/v range, fermenting the mixture and clarifying the resulting broth, adding a sweetener to the broth selected from the group comprising corn sugar, sucrose, sorbose stabilizer, and a low calorie sweetener, carbonating the beverage, bottling and cold storing the same.

### CROSS REFERENCE TO RELATED APPLICATION

This application claims benefit under Title 35, USC §119(e) of U.S. Provisional Application Serial No. 60/153,499.

### FIELD OF THE INVENTION

This invention relates to midrange alcoholic fruit ciders made from fruit juices and purees including orange juice, grapefruit juice, pineapple juice, cherry juice, blueberry juice or puree, cranberry juice or puree, blackberry juice or puree, apricot juice or puree, prune juice, guava juice or puree, raspberry juice or puree, peach juice, lemon juice, lime juice, strawberry juice or puree, kiwi fruit juice or puree, and tomato juice and to a method for making same.

### BACKGROUND OF THE INVENTION

Some fruit juices ferment naturally and have been used for many years to make alcoholic beverages, notably grape juice for making wine and apple juice for making hard (alcoholic) cider. More recently numerous fruit juices and fruits have been used for making high range alcoholic wines of 11 to 14% ethanol. Among these are blueberries, oranges and orange juice (U.S. Pat. No. 3,979,521, JP 60,30674, JP 60,30674, JP 62,248801, JP 55,127983, JP 64,055174, JP 6,205664, JP 54,73199, JP 57,144967, JP 3,266948, JP 1,179647, JP 60,043376, JP 62,294024, DE 2,357,970 and FR 2,657,878), apples and apple juice, and other fruits like guava. In these products enough sugar is added to obtain either dry or sweet mostly non-sparkling wines similar in alcoholic content to wines made from grape juice (11 to 14%).

### SUMMARY OF THE INVENTION

The present invention relates to alcoholic fruit beverages with midrange alcohol content typical of cider and beers (3.5 to 7.5% and preferably 4.5 to 6% ethanol) which are both carbonated with carbon dioxide gas and sweetened with a suitable sweetener to give a refreshing fruit flavor. In the case of orange juice, grapefruit juice, peach juice, cherry juice, and pineapple juice only the natural sugars are fermented giving a totally natural fermented beverage while in the case of lemon juice, lime juice, blueberry juice or puree, raspberry juice or puree, black berry juice or puree, and cranberry juice or puree, sugar, preferably derived from corn, cane, beet or barley malt, and water are added to the juices or purees to arrive at midrange alcohol levels typical of beers or hard apple cider. When a low calorie sweetener is employed, these healthful drinks have only caloric value from the ethanol content and hence are low calorie alcoholic beverages. This class of alcoholic fruit beverage products is made by a general unifying method of cold fermentation with a special nutrient mineral salts mixture. The mixture is preferably about 13 parts nitrogen, 7 parts potassium, 3 parts phosphorous, and 1 part magnesium and, further, preferably as set forth in Table I below. A suitable yeast such as Saccharomyces cerivisiae or Saccharomyces carlsbergensis is aided and fermentation continues for about ten days until all the sugar which typically starts at 10 to 12% w/v is converted to ethanol at about 5 to 6% v. The fermentation step is followed by clarification which may employ gravity settling, a filter or a centrifuge to remove yeast. Then the clarified ferment is carbonated preferably by sparging with carbon dioxide gas under suitable pressure, temperature and mixing. Before carbonation, the clarified ferment is sweetened with aspartame or a sugar such as sucrose or glucose and a stabilizer like potassium sorbate to the desired sweetness which complements the acidity of the cider.

TABLE I

| | APPROXIMATE gms per 100 gms |
|---|---|
| Ammonium chloride | 61 |
| Yeast extract | 3 |
| Potassium phosphate | 20 |
| Magnesium sulfate heptahydrate | 14 |
| Thiamine hydrochloride | 2 |

### DESCRIPTION OF THE PREFERRED EMBODIMENTS

The process by which these midrange alcoholic fruit beverage products are made is illustrated by the following examples:

### EXAMPLE 1

Three gallons of orange juice (from concentrate but pasteurized and clarified of pulp) is poured into a glass fermentor. Five grams of specially designed mineral salts mixture given in Table 1 and 10 gm of Epernay yeast were added. A fermentation lock was installed and the cold juice was fermented at 48° F. for 9 days to dryness. The fermentor was racked off the lees and to the ferment was added 45 gm of aspartame and 60 grams of corn sugar after which the cider was bottled in 22 ounce bottles and held at 48° F. for three days for carbonation by bottle conditioning. The resulting alcoholic sweetened sparkling orange cider was tasted and had a fresh orange juice fruitiness but was not as sweet similar, to a mimosa made from orange juice and champagne.

### EXAMPLE 2

Fifteen pounds of fresh high bush blueberries were pureed in a blender and added to a 5-gallon open top stainless steel fermentor. To the puree was added 1900 gms of corn sugar and enough water to bring the total volume to 5 gallons. The pH of the slurry was adjusted to 4 with an acid blend, a gram of metabisulfite was added and 10 drops of Rapidase enzyme solution. To the mixture was added 10 gm of Epernay yeast and 5 gram of specially designed mineral salts mixture as given in Table 1 and the fermentor was held at 48° F. for 10 days until the brix was 0. The slurry was poured into a cotton sack and the cider was pressed out along with free run in a small basket press. Forty grams of aspartame was added and 100 grams of corn sugar before bottling in 22 ounce bottles which were stored at 48° F. for three days for bottle conditioning. The finished cider was tasted and had a fresh blueberry flavor that was heightened by the carbonation present.

### EXAMPLE 3

One gallon of pineapple juice was put in a glass fermentor and 1 gram each of Table 1 mineral salts mixture and Epernay yeast were added. The fermentor was held at 48° F. for 10 days and the resulting ferment was clarified as in Example 1. The clarified ferment was sweetened with aspartame and carbonated by bottle conditioning in the same manner as Example 1. The pineapple cider was tasted and a pineapple flavor was still present along with ethanol highlights.

### EXAMPLE 4

One gallon of grapefruit juice pasteurized and clarified of pulp was treated similarly to Examples 1 and 3 fermented, clarified and sweetened and carbonated as before and after bottle conditioning tasted. The cider tasted like fresh grapefruit juice but not as sweet with ethanol highlights.

### EXAMPLE 5

A blend of 27% cranberry juice and water was put in a one gallon fermentor and the sugar level was adjusted to 10° brix. One gram of the mineral salts mixture of Table 1 was added and 5 grams of Epernay yeast. The fermentor was held at 48° F. for 10 days and fermented to dryness. The broth was clarified and then sweetened with 8 gm of aspartame and 20 gm of corn sugar and bottle conditioned at 48° F. for 3 days after which it was tasted. It had a taste like cranberries, was slightly sweet, effervescent and refreshing.

### EXAMPLE 6

Six 50 gallon drums of grapefruit juice concentrate were diluted with filtered water five to one making a volume of 1800 gallons of single strength grapefruit juice in a mix tank. To the juice was added 1.8 kg of the specially designed Table 1 mineral salts mixture and 2 kg of dry Epernay yeast. After mixing, the mixture was pumped to a 2000 gallon stainless steel jacketed fermentor and cooled to 55 degrees F. The fermentation proceeded for 12 days until all of the natural sugars had been depleted. The fermentor was cooled to 34 degrees F. and yeast allowed to settle to the bottom of the fermentor. The fermentor was racked off the lees to a mixing tank and sweetened with 600 pounds of cane sugar. It was then pumped to a carbonating tank and sparged with carbon dioxide gas under 10 pounds of pressure for 12 hours to carbonate to about 2.5 volumes of CO² per volume of liquid. The resulting sweetened and carbonated clarified grapefruit cider was bottled on a automated counter pressure filler, capper, in labeled 12 ounce clear bottles. The bottles were stored at room temperature and tasted each day for a week. The taste was very pleasing like fresh grapefruit juice with effervescence and alcohol overtones.

### EXAMPLE 7

Seventy-five gallons of cranberry juice concentrate was diluted with filtered water 24 to one to make up 1875 gallons of juice. In a mix tank with whirlpool mixing 1875 pounds of corn sugar was blended into solution as well as 1.875 Kg of the specially designed mineral salts mixture of Table 1, and 2 kg of dry Epernay yeast. The mixture was pumped to a 2000 gallon fermentor and cooled to 55 degrees F. and allowed to ferment to dryness (Obrix) in 12 days. The fermentor was chilled to 34 degrees F. to aid clarification of yeast and racked to a mixing tank while simultaneously being filtered through a diatomaceous earth filter. It was then sweetened with 625 pounds of cane sugar and pumped to a carbonating tank and held at the same temperature and 10 psi of pressure and sparged with carbon dioxide gas as in Example 6 to the same degree of carbonation and then bottled on an automated counter pressure filler/capper as in the previous example. The resulting sweetened, sparkling cranberry cider was tasted and exhibited a distinct cranberry flavor and pleasing effervescence with alcohol overtones.

### EXAMPLE 8

To 1 liter of reconstituted lime juice (from concentrate) 5 liters of filtered water and 720 grams of cane sugar was added and mixed. Five grams of Epernay yeast was added and one gram of specially designed mineral salts were blended in and the mixture was fermented for 12 days at 60° Fn a glass carboy. The lime cider was racked off the lees and sweetened with 250 grams of cane sugar and stabilized with 2 grams of potassium sorbate. The clarified fermented sweetened cider was carbonated in one liter batches and bottled in 12 ounce bottles while at 22° to avoid foaming. The resulting sparkling cider tasted of lime with a pleasing effervescence and alcohol overtones.

### EXAMPLE 9

To 300 gallons of tomato concentrate (paste) 1500 gallons of filtered water was added in a mix tank and blended. Then 1650 pounds of corn sugar (dextrose monohydrate) was added and mixed into solution. To the solution was added 2 kg of epecially designed mineral salts as in Table 1 and 2 kg of Epernay yeast. The 1800 gallons of mixture was pumped to a stainless steel jacketed fermentor and topped off with 75 gallons of filtered water. Temperature was controlled at 60 degrees F. for 10 days until the fermentation reached dryness and all sugar was depeleted. About 1800 gallons of fermented cider was racked off the lees into a mixing tank and mixed with 400 pounds of cane sugar and 2 kg of potassium sorbate. The mixture was then pumped to a stainless steel carbonating tank and temperature was cooled to 35 degrees F. and sparged under 10 psi head pressure with carbon dioxide gas for 12 hours until saturated at about 2 volumes of CO² gas per volume of cider. The tomato cider was then bottled under pressure in a automated counter pressure filler and stored at 68 degrees F.

1. A method for making a mid-range carbonated and sweetened alcoholic fruit cider with 3.5 to 7.5% ethanol comprising the steps of:
selecting a fruit juice or puree to form the desired flavor base of the beverage;
adding a nutrient mineral salts mixture;
adding sugar as required to establish an initial sugar level in the 8 to 14% w/v range;
fermenting the mixture at 35 to 65 degrees Fahrenheit until dry;
clarifying the resulting broth;
adding a sweetener to the broth selected from the group comprising corn sugar, sucrose and sorbose stabilizer, and a low calorie sweetener such as aspartame;
carbonating the beverage; and
bottling and cold storing the beverage until consumption.

2. A method for making a mid-range carbonated and sweetened alcoholic fruit cider as set forth in claim 1 wherein the nutrient mineral salts mixture has a ratio of approximately 13 parts nitrogen, 7 parts potassium, 3 parts phosphorus, and 1 part magnesium.

3. A method for making a mid-range carbonated and sweetened alcoholic fruit cider as set forth in claim 1 wherein the sugar is derived from corn, cane, beet or barley malt.

4. A method for making a mid-range carbonated and sweetened alcoholic fruit cider as set forth in claim 1 wherein the nutrient mineral salts mixture is as set forth in TABLE I below:
TABLE I

| | APPROXIMATE gms per 100 gms |
|---|---|
| ammonium chloride | 61 |
| yeast extract | 3 |
| potassium phosphate | 20 |
| magnesium sulfate heptahydrate | 14 |
| thiamine hydrochloride | 2 |

5. A method for making a mid-range carbonated and sweetened alcoholic fruit cider as set forth in claim 1 wherein the fruit juice or puree is selected from a group comprising orange juice, grapefruit juice, pineapple juice, cherry juice, tomato juice, blueberry juice or puree, cranberry juice or puree, blackberry juice or puree, apricot juice or puree, prune juice, guava juice or puree, raspberry juice or puree, peach juice, lemon juice, lime juice, strawberry juice or puree, and kiwi fruit juice or puree.

6. A method for making a mid-range carbonated and sweetened alcoholic fruit cider as set forth in claim 1 wherein the fruit cider has a Ethanol content in the range of 4.5 to 6.5%.

7. A method for making a mid-range carbonated and sweetened alcoholic fruit cider as set forth in claim 1 wherein the Ethanol content of the fruit cider falls in the range of 5 to 6%.

8. A method for making a mid-range carbonated and sweetened alcoholic fruit cider as set forth in claim 1 wherein the fruit cider has an Ethanol content in the range of 4.5 to 6.5% and wherein sugar is added as required to establish an initial sugar level in the 10 to 12% w/v range.

9. A method for making a mid-range carbonated and sweetened alcoholic fruit cider as set forth in claim 1 wherein the yeast added is Saccharomyces cerivisiae.

10. A method for making a mid-range carbonated and sweetened alcoholic fruit cider as set forth in claim 1 wherein the yeast added is Saccharomyces carlsbergensis.

11. A method for making a mid-range carbonated and sweetened alcoholic fruit cider as set forth in claim 1 wherein the yeast is Epernay.

12. A method for making a mid-range carbonated and sweetened alcoholic fruit cider as set forth in claim 5 wherein orange juice is selected.

13. A method for making a mid-range carbonated and sweetened alcoholic fruit cider as set forth in claim 5 wherein grapefruit juice is selected.

14. A method for making a mid-range carbonated and sweetened alcoholic fruit cider as set forth in claim 5 wherein pineapple juice is selected.

15. A method for making a mid-range carbonated and sweetened alcoholic fruit cider as set forth in claim 5 wherein cherry juice is selected.

16. A method for making a mid-range carbonated and sweetened alcoholic fruit cider as set forth in claim 5 wherein prune juice is selected.

17. A method for making a mid-range carbonated and sweetened alcoholic fruit cider as set forth in claim 5 wherein peach juice is selected.

18. A method for making a mid-range carbonated and sweetened alcoholic fruit cider as set forth in claim 5 wherein lemon juice is selected.

19. A method for making a mid-range carbonated and sweetened alcoholic fruit cider as set forth in claim 5 wherein lime juice is selected.

20. A method for making a mid-range carbonated and sweetened alcoholic fruit cider as set forth in claim 5 wherein tomato juice is selected.

21. A method for making a mid-range carbonated and sweetened alcoholic fruit cider as set forth in claim 5 wherein blueberry juice or puree is selected.

22. A method for making a mid-range carbonated and sweetened alcoholic fruit cider as set forth in claim 5 wherein cranberry juice or puree is selected.

23. A method for making a mid-range carbonated and sweetened alcoholic fruit cider as set forth in claim 5 wherein blackberry juice or puree is selected.

24. A method for making a mid-range carbonated and sweetened alcoholic fruit cider as set forth in claim 5 wherein apricot juice or puree is selected.

25. A method for making a mid-range carbonated and sweetened alcoholic fruit cider as set forth in claim 5 wherein guava juice or puree is selected.

26. A method for making a mid-range carbonated and sweetened alcoholic fruit cider as set forth in claim 5 wherein raspberry juice or is selected.

27. A method for making a mid-range carbonated and sweetened alcoholic fruit cider as set forth in claim 5 wherein strawberry juice or puree is selected.

28. A method for making a mid-range carbonated and sweetened alcoholic fruit cider as set forth in claim 5 wherein kiwi fruit juice or puree is selected.

29. An alcoholic, sparkling, sweetened fruit cider with Ethanol content in the range 3.5 to 7.5% made by the following method:
selecting a fruit juice or puree to form the desired flavor base of the beverage from a group comprising orange juice, grapefruit juice, pineapple juice, cherry juice, tomato juice, blueberry juice or puree, cranberry juice or puree, blackberry juice or puree, apricot juice or puree, prune juice, guava juice or puree, raspberry juice or puree, peach juice, lemon juice, lime juice, strawberry juice or puree, and kiwi fruit juice or puree.
adding yeast and a mineral salts mixture as set forth in TABLE I below:
TABLE I

| | APPROXIMATE gms per 100 gms |
|---|---|
| Ammonium chloride | 61 |
| Yeast extract | 3 |
| Potassium phosphate | 20 |
| Magnesium sulfate heptahydrate | 14 |
| Thiamine hydrochloride | 2 |

adding sugar as required to establish an initial sugar level in the 8 to 14% w/v range;
fermenting the mixture and clarifying the resulting broth;
adding a sweetener to the broth selected from the group comprising corn sugar, sucrose and sorbose stabilizer, and a low calorie sweetener;
carbonating the beverage; and
bottling and cold storing the same.
